(19) United States
(12) Patent Application Publication
(10) Pub. No.: US 2012/0027363 A1
(43) Pub. Date: Feb. 2, 2012

(54) OPTICAL ELECTRONIC CONNECTING DEVICE WITH DUAL MODULES

(75) Inventors: HOU-AN SU, KEELUNG CITY (TW); HAI-WEN YANG, SHANXI PROVINCE (CN); XUAN LUO, HUBEI PROVINCE (CN); XIAO-QIONG LIAO, HUNAN PROVINCE (CN); HAI-YANG XIAO, HUNAN PROVINCE (CN)

(73) Assignee: NEXTRONICS ENGINEERING CORP., TAIPEI HSIEN (TW)

(21) Appl. No.: 12/845,141

(22) Filed: Jul. 28, 2010

(51) Int. Cl. G02B 6/36

(52) U.S. Cl. 385/92

(57) ABSTRACT

An optical electronic connecting device with dual modules includes a first module and a second module. The first module meets the specification of a Small Form-Factor Pluggable connector. The first module includes a first main body, a plurality of first terminals, and a first metallic casing. The second module meets the specification of a RJ connector. The second module includes a second main body, a plurality of second terminals, and a second metallic casing. The first module and the second module are stacked together and respectively have a metallic casing. The optical electronic connecting device with dual modules has a simplified configuration, can be produced easily with lower cost, and therefore can be sold at lower price.

### BACKGROUND OF THE INVENTION

1. Field of the Invention

The present invention relates to an optical electronic connecting device, and in particular, to an optical electronic device having two modules of different specifications for network interface.

2. Description of Related Art

A transceiver module is usually used to connect a circuit board for communication wirings to other electronic modules or devices. For example, a computer can be connected to an external communication device such as a modem, network interface or other transceiver modules. A GBIC (Gigabit Interface Converter) is a well-known transceiver responsible to communicate a computer with an Ether network, optical fiber channel, or other data communication environment.

In order to increase the port density when a network switch, a cable plug panel, a wire box, or a computer I/O port is interconnected, the transceiver is expected to be miniaturized. A Small Form-Factor Pluggable (SFP) transceiver has been developed to meet this need, with the primary benefit being half the size of GBIC, which allows greater port density for the communication system.

A conventional connector for the SFP transceiver module can be used to plug in a corresponding connector. The SFP transceiver module can also connect to a corresponding connector of RJ45 type through a converter. Taiwan Patent No. M246868 discloses a SFP transceiver module pluggable to an external shielding socket, which includes a printed circuit board, a RJ connector mechanically connected to the printed circuit board, and a clipping part used to connect the RJ connector to the printed circuit board. The clipping part is used to fasten the RJ connector to the printed circuit board.

However, the above SFP transceiver module needs complicate wire routings for the conversion of optical electronic signals, causing high production cost and retail prices.

Therefore, there is a need of an optical electronic connecting device which overcomes the above disadvantages.

### SUMMARY OF THE INVENTION

The object of the present invention is to provide an optical electronic connecting device which has a simplified configuration, can be produced easily with lower cost, and therefore can be sold at lower price.

In order to achieve the aforementioned objects, according to an embodiment of the present invention, an optical electronic connecting device with dual modules includes a first module and a second module. The first module meets the specification of a Small Form-Factor Pluggable connector and includes a first main body, a plurality of first terminals, and a first metallic casing. The first main body has a plurality of first terminal slots and a first insertion slot. The first terminals are accommodated in the first terminal slots and stretch into the first insertion slot. The first metallic casing encloses the whole first main body. The second module meets the specification of a RJ connector and includes a second main body, a plurality of second terminals, and a second metallic casing. The second main body has a plurality of second terminal slots and a second insertion slot. The second terminals are accommodated in the second terminal slots and stretch into the second insertion slot. The second metallic casing encloses the whole second main body. The first module and the second module are stacked together.

The invention offers the following advantages. The first module meets the specification of a SFP connector and the second module meets the specification of a RJ connector so that the optical electronic connecting device has interfaces of different specifications. The first module and the second module, respectively of different specifications, are stacked together as an integrated body where the first module and the second module have separate wire routings. Therefore, no further wiring is required for optical electronic signal conversion, and an optical electronic connecting device of simplified configuration and production process can be achieved with lower production cost and selling price.

In order to further the understanding regarding the present invention, the following embodiments are provided along with illustrations to facilitate the disclosure of the present invention.

### BRIEF DESCRIPTION OF THE DRAWINGS

FIG. 1 shows a perspective, exploded view of an optical electronic connecting device according to an embodiment of the present invention;

FIG. 2 shows a perspective view of an optical electronic connecting device according to an embodiment of the present invention;

FIG. 3 is a front view of an optical electronic connecting device according to an embodiment of the present invention;

FIG. 4 is a side view of an optical electronic connecting device according to an embodiment of the present invention;

FIG. 5 shows a bottom view of an optical electronic connecting device according to an embodiment of the present invention; and

FIG. 6 shows a schematic view of an optical electronic connecting device in operating status according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

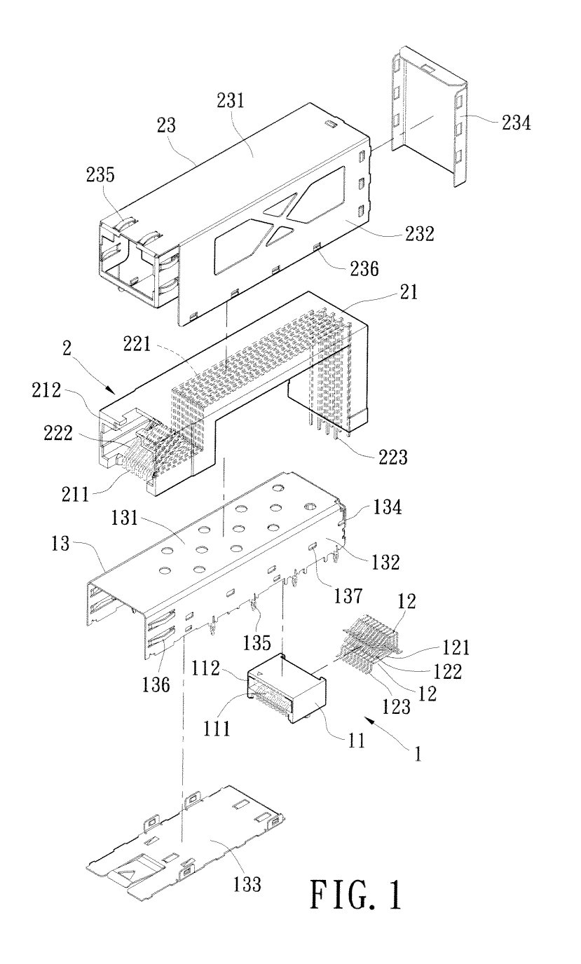

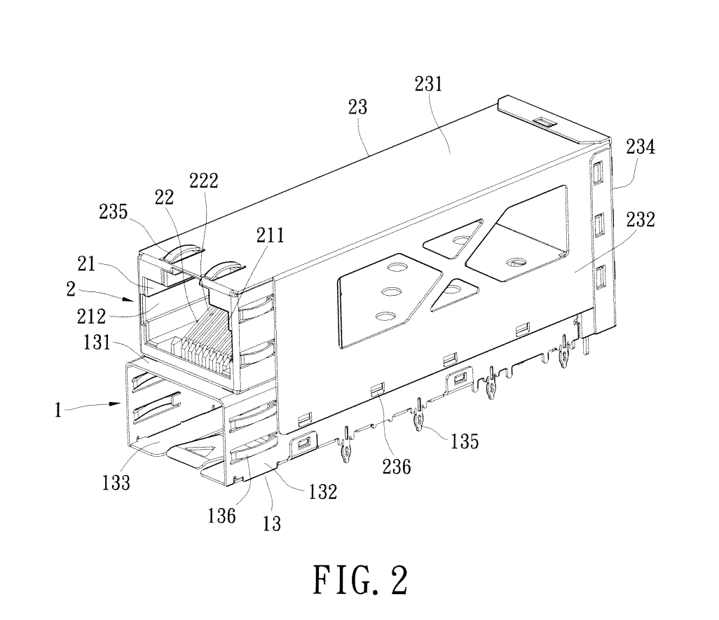

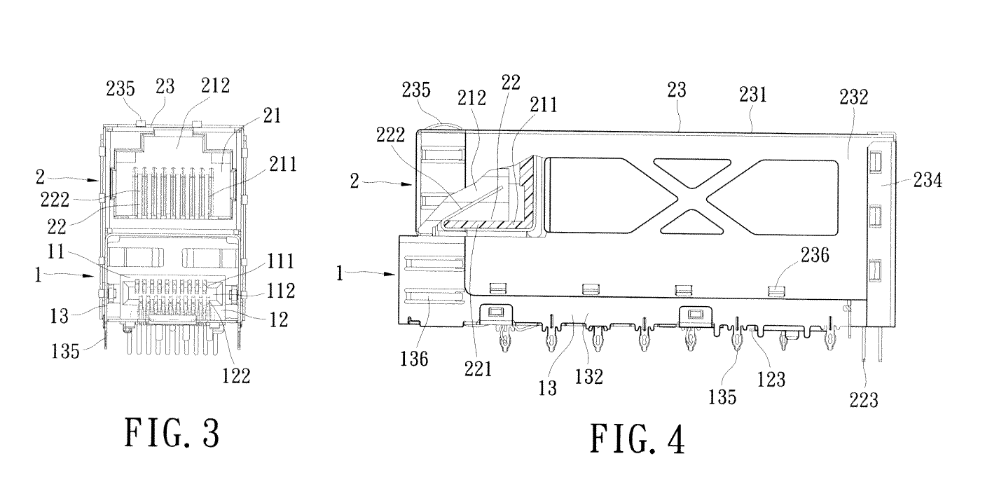

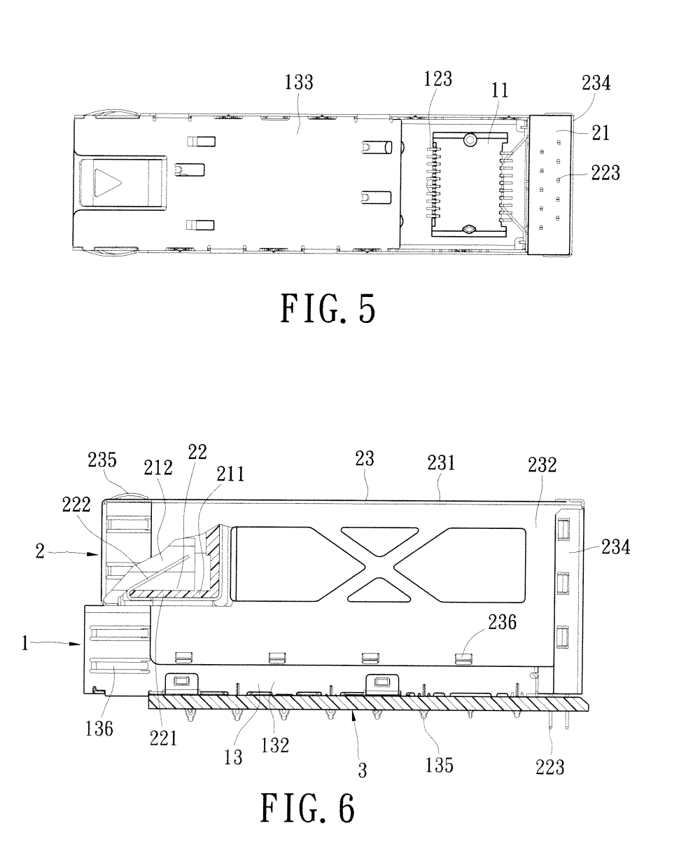

Referring to FIG. 1 through FIG. 6, an optical electronic connecting device with dual modules according to the invention includes a first module 1 and a second module 2. The first module 1 and the second module 2 are stacked together. In present embodiment, the second module 2 is placed on top of the first module 1. The first module 1 meets the specification of small form-factor pluggable (SFP) connector and includes a first main body 11, a plurality of first terminals 12, and a first metallic casing 13. The rectangular first main body 11 is made of insulating material such as plastics. The first main body 11 has a plurality of first terminal slots 111 and a first insertion slot 112. The first terminal slots 111 are located above and under the first insertion slot 112.

The first terminals 12 respectively meet the specification of terminals of the SFP connector. The first terminals 12 are located on the first main body 11, and accommodated in the corresponding first terminal slots 111. The first terminals 12 respectively have a fixing part 121, a contacting part 122, and a soldering part 123. The contacting part 122 and the soldering part 123 are formed by extending from the corresponding ends of the fixing part 121. The fixing parts 121 of the first terminals 12 are fastened onto the first main body 11. The contacting parts 122 of the first terminals 12 respectively stretch into the first insertion slot 112 so as to electrically connect to terminals of a corresponding connector. The soldering parts 123 of the first terminals 12 extend outside the bottom surface of the first main body 11 for soldering onto a circuit board 3. Thereby, the first module 1 is electrically connected to the circuit board 3.

The first metallic casing 13 encloses the whole first main body 11. The first metallic casing 13 is a shielding element that can prevent any electromagnetic interference. The first metallic casing 13 includes a top plate 131, two sidewalls 132, a bottom plate 133, a rear lid 134, a plurality of insertion legs 135, and a plurality of grounded elastic pieces 136. The top plate 131 and the two sidewalls 132 are rectangular and made of metallic material. The two sidewalls 132 locate at opposite sides of the top plate 131. The bottom plate 133 is rectangular and metallic, and clips onto the bottom edges of the two sidewalls 132. The top plate 131, the two sidewalls 132, and the bottom plate 133 together form a rectangular casing. The rear lid 134 is rectangular and metallic, and connects to the rear of the top plate 131 and the two sidewalls 132. The insertion legs 135 are formed by extending from the bottom edges of the sidewalls 132 and the rear lid 134 for insertion into the circuit board 3, thereby anchoring the optical electronic connecting device onto the circuit board 3. The grounded elastic pieces 136 are located on the sidewalls 136 of the first metallic casing 13 near the first terminals 12. The grounded elastic pieces 136 extend outward from the first metallic casing 13. The grounded elastic pieces 136 can connect to external grounding sources (not shown) in order to prevent any electromagnetic interference. The first metallic casing 13 is exemplified for illustration in certain embodiments, and therefore is not limited to the above configuration. The first metallic casing 13 can have any variety as a metallic casing for an appropriate electric connecting device.

The second module 2 meets the specification of a RJ connector. In this embodiment, the second module 2 is a RJ45 connector (RJ45 socket) and stacks on top of the first module 1. The second module 2 includes a second main body 21, a plurality of second terminals 22, and a second metallic casing 23. The second main body 21 is made of insulating material such as plastics and has a rectangular shape. The main body 21 has a plurality of second terminal slots 211 and a second insertion slot 212. The second insertion slot 212 has a dimension corresponding to the standard specification of a RJ45 plug so that a RJ45 plug can be inserted into the second insertion slot 212.

The second terminals 22 respectively meet the specification of the terminals of the RJ45 connector. The second terminals 22 are accommodated in the corresponding second terminal slots 211. The second terminals 22 respectively have a fixing part 221, a contacting part 222, and a soldering part 223. The contacting part 222 and the soldering part 223 are formed by extending from the corresponding ends of the fixing part 221. The fixing parts 221 of the second terminals 22 are connected onto the second main body 21. The contacting parts 222 of the second terminals 22 respectively stretch into the second insertion slot 212 so as to electrically connect to the terminals of a corresponding connector such as a RJ45 plug. The soldering parts 223 of the second terminals 22 extend out of the bottom of the second main body 21 for soldering onto the circuit board 3. In this embodiment, the first module 1 and the second module 2 are both placed on the circuit board 3.

The metallic casing 23 encloses the whole second main body 21. The second metallic casing 23 is a shielding element that can prevent any electromagnetic interference. The second metallic casing 23 includes a top plate 231, two sidewalls 232, a rear lid 234, and a plurality of grounded elastic pieces 235. The top plate 231 and the two sidewalls 232 together form a rectangular hollow casing. The rear lid 234 is clipped onto the rear of the two sidewalls 232. The grounded elastic pieces 235 are located on the top plate 231 and the sidewalls 232 of the second metallic casing 23, near the second terminals 22. The grounded elastic pieces 235 extend outward from the second metallic casing 23. The grounded elastic pieces 235 can connect to external grounding sources (not shown) in order to prevent any electromagnetic interference. The second metallic casing 23 is exemplified for illustration in certain embodiments, and therefore is not limited to the above configuration. The second metallic casing 23 can have any variety as a metallic casing for an appropriate electric connecting device. The second metallic casing 23 is stacked over the first metallic casing 13. The two sidewalls 232 of the second metallic casing 23 has a fastening part 236, which is connected to the fastening part 137 on the two sidewalls 132 of the first metallic casing 13. The fastening part 236 and 137 can be fastening holes and fasteners respectively. As a commom inner wall, the top plate 131 of the first metallic casing 13 acts as a partition plate between the first module 1 and the second module 2.

In another embodiment of the invention, the optical electronic connecting device is set onto the circuit board 3 in a different way (not shown), where the first module 1 is placed on the top surface of the circuit board 3, and the second module 2 is placed on the bottom surface of the circuit board 3, and vice versa.

The first module 1 in the invention meets the specification of a SFP connector and the second module 2 meets the specification of a RJ connector so that the optical electronic connecting device has interfaces of different specifications. The first module 1 and the second module 2, respectively of different specifications, are stacked together as an integrated body in a manner that the first module 1 and the second module 2 have separate wire routings. Therefore, there is no need for complicate wirings for converting the optical electronic signal, and an optical electronic connecting device of simplified configuration and production process can be achieved with lower production cost and selling price.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An optical electronic connecting device with dual modules, comprising:
a first module, meeting the specification of a Small Form-Factor Pluggable connector and comprises a first main body, a plurality of first terminals, and a first metallic casing; the first main body having a plurality of first terminal slots and a first insertion slot; the first terminals being accommodated in the first terminal slots; the first terminals stretching into the first insertion slot; and the first metallic casing enclosing the whole first main body; and
a second module, meeting the specification of a RJ connector and comprises a second main body, a plurality of second terminals, and a second metallic casing; the second main body having a plurality of second terminal slots and a second insertion slot; the second terminals being accommodated in the second terminal slots; the second terminals stretching into the second insertion slot; the second metallic casing enclosing the whole second main body; and the first module and the second module are stacked together.

2. The optical electronic connecting device with dual modules according to claim 1, characterized in that the second module is stacked on top of the first module.

3. The optical electronic connecting device with dual modules according to claim 2, characterized in that the first metallic casing comprises a top plate, two sidewalls, and a bottom plate in forming a rectangular hollow casing, and a plurality of insertion legs that extend from the bottom edges of the two sidewalls.

4. The optical electronic connecting device with dual modules according to claim 3, characterized in that the second metallic casing comprises a hollow casing defined by a top plate and two sidewalls, the second metallic casing is stacked on top of the first metallic casing, and two sidewalls of the second metallic casing respectively have a fastening part that connects to the corresponding fastening part on the two sidewalls of the first metallic casing.

5. The optical electronic connecting device with dual modules according to claim 1, characterized in that the first module in placed on the top surface of a circuit board, and the second module is placed on the bottom surface of the circuit board, and vice versa.

6. The optical electronic connecting device with dual modules according to claim 1, characterized in that the first terminal slots are placed inside the first insertion slot, the first terminals respectively have a fixing part, a contacting part, and a soldering part; the fixing parts of the first terminals are connected to the first main body; the contacting parts of the first terminals respectively stretch into the first insertion slot; and the soldering parts of the first terminals extend outside the bottom edge of the first main body.

7. The optical electronic connecting device with dual modules according to claim 1, characterized in that the second module is a RJ45 connector.

8. The optical electronic connecting device with dual modules according to claim 1, characterized in that the second terminals respectively have a fixing part, a contacting part, and a soldering part; the fixing parts of the second terminals are connected to the second main body; the contacting parts of the second terminals respectively stretch into the second insertion slot; and the soldering parts of the second terminals extend outside the bottom edge of the second main body.

9. The optical electronic connecting device with dual modules according to claim 1, characterized in that a partition plate is in place between the first module and the second module as a common inner wall for the first module and the second module.

10. The optical electronic connecting device with dual modules according to claim 1, characterized in that the first metallic casing communicates with and connects to the second metallic casing.
